(19) United States
(12) Patent Application Publication
(10) Pub. No.: US 2026/0332014 A1
(43) Pub. Date: Oct. 22, 2026

(54) ELECTRIC DEVICE

(71) Applicants: INOAC CORPORATION, Nagoya-shi, Aichi-ken (JP); NAGOYA INSTITUTE OF TECHNOLOGY, Nagoya-shi, Aichi-ken (JP)

(72) Inventors: Nobuyuki MAKIHARA, Okazaki-shi (JP); Yasushi IDO, Nagoya-shi (JP); Yuhiro IWAMOTO, Gifu-shi (JP)

(73) Assignees: INOAC CORPORATION, Nagoya-shi, Aichi-ken (JP); NAGOYA INSTITUTE OF TECHNOLOGY, Nagoya-shi, Aichi-ken (JP)

(21) Appl. No.: 19/105,900

(22) PCT Filed: Oct. 28, 2022
(86) PCT No.: PCT/JP2022/040560

§ 371 Date: Feb. 24, 2025

(51) Int. Cl. H02K 35/02; H01F 1/08; H01M 10/44; H02K 1/02

(52) U.S. Cl. CPC H02K 35/02; H01M 10/44; H02K 1/02; H01F 1/083

(57) ABSTRACT

An electric device includes: an electromagnetic induction coil; an elastic body containing a magnetized magnetic powder and configured to generate a magnetic field passing through the electromagnetic induction coil and to change a magnetic flux density of the magnetic field when elastically deformed by receiving an external force; a rectifier unit configured to rectify an induced current induced in the electromagnetic induction coil by a change in the magnetic flux density; a load unit configured to operate by receiving the induced current from the rectifier unit; and a case accommodating the electromagnetic induction coil and the elastic body and being extensible and contractible together with the elastic body.

### DESCRIPTION

### Technical Field

The present disclosure relates to a self-powered electric device.

### Background Art

As this type of conventional electric device, a device has been known that performs self-power generation by a rotary machine that is rotationally driven by an external force (see, for example, Patent Document 1).

### RELATED ART DOCUMENTS

### Patent Documents

Patent Document 1: JP 2012-515860 A (FIG. 4, Claim 11)

### SUMMARY OF THE INVENTION

### Problems to Be Solved By the Invention

However, the conventional electric device described above has a complicated structure because of having the rotary machine, which may cause a failure. Therefore, the present disclosure provides an electric device capable of driving a load unit by converting vibration, displacement, and the like from an external force into electric power to perform self-power generation with a simpler structure than the conventional one.

### Means of Soloving the Problems

One aspect of the present invention made to solve the above problems is an electric device including: an electromagnetic induction coil; an elastic body containing a magnetized magnetic powder and configured to generate a magnetic field passing through the electromagnetic induction coil and to change a magnetic flux density of the magnetic field when elastically deformed by receiving an external force; a rectifier unit configured to rectify an induced current induced in the electromagnetic induction coil by a change in the magnetic flux density; and a load unit configured to operate by receiving the induced current from the rectifier unit.

### BRIEF DESCRIPTION OF THE DRAWINGS

FIG. 1 is a circuit diagram of an electric device according to a first embodiment of the present disclosure.

FIG. 2 is a perspective view of the electric device.

FIG. 3 is a cross-sectional side view of the electric device.

FIG. 4 is a conceptual diagram of a power generation unit.

FIG. 5(A) is a conceptual diagram illustrating a magnetic powder in a magnetic elastic body, and FIG. 5(B) is a conceptual diagram of the compressed magnetic elastic body.

FIG. 6 is a flowchart illustrating a method for producing the magnetic elastic body.

FIG. 7(A) is a conceptual diagram illustrating magnetization of the magnetic elastic body before compression deformation, and FIG. 7(B) is a conceptual diagram illustrating magnetization of the magnetic elastic body and an induced current during compression deformation.

FIG. 8(A) is a conceptual diagram illustrating a magnetic field by the magnetic elastic body and magnetization of the magnetic elastic body before compression deformation, and FIG. 8(B) is a conceptual diagram illustrating an induced magnetic field and an induced current generated in a coil and a circuit when the magnetic elastic body is compressed.

FIG. 9(A) is a conceptual diagram illustrating a magnetic field by the magnetic elastic body and magnetization of the magnetic elastic body before compression deformation, and FIG. 9(B) is a conceptual diagram illustrating an induced magnetic field and an induced current generated in two coils and circuits when the magnetic elastic body is compressed.

FIG. 10 is a circuit diagram of an electric device according to a second embodiment.

FIG. 11(A) is a conceptual diagram of an electric device of a third embodiment, and FIG. 11(B) is a partially cutaway side view in a state where the electric device is attached to a suspension.

FIG. 12 is a conceptual diagram of an electric device of a fourth embodiment.

FIG. 13 is a cross-sectional side view of a floor structure including an electric device of a fifth embodiment.

FIG. 14 is a perspective view of an electric device of a sixth embodiment.

FIG. 15 is a perspective view of an electric device of a seventh embodiment.

FIG. 16(A) is a cross-sectional side view of an electric device of an eighth embodiment, and FIG. 16(B) is a cross-sectional side view of the electric device subjected to bending deformation.

FIG. 17 is a perspective view of an electric device of a ninth embodiment.

FIG. 18 is a conceptual diagram of a testing apparatus.

FIG. 19 is a table showing the details and properties of magnetic elastic bodies of experimental examples.

### MODE FOR CARRYING OUT THE INVENTION

### First Embodiment

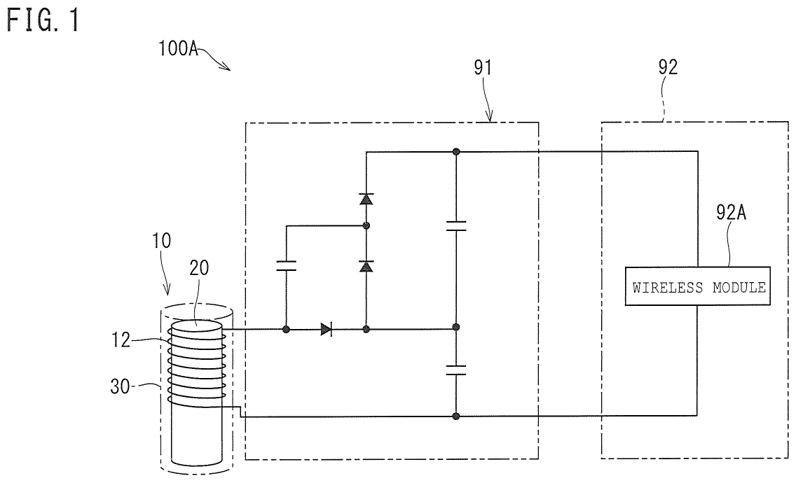

An electric device 100A according to one embodiment of the present disclosure will be described with reference to FIGS. 1 to 9. As illustrated in FIG. 1, the electric device 100A of the present embodiment includes a power generation unit 10, a rectifier unit 91, and a load unit 92.

The load unit 92 includes, for example, a wireless module 92A. The wireless module 92A is, for example, a modification of RFID. An RFID tag wirelessly receives electric power, and modulates an identification number to a carrier of short-range wireless communication and wirelessly transmits the carrier every time receiving the electric power, whereas the wireless module 92A receives electric power by wire from the power generation unit 10 through the rectifier unit 91, and modulates an identification number to a carrier wave of predetermined wireless communication and transmits the carrier wave every time receiving the electric power. Examples of the predetermined wireless communication include long-range wireless communication, Wi-Fi, infrared communication, and short-range wireless communication.

Note that the wireless module 92A may modulate information other than the identification number to a carrier wave and wirelessly transmit the carrier wave, or may transmit only a radio wave of a specific frequency that does not include information without modulating information to a carrier wave such that transmitting the radio wave itself is regarded as information from the electric device 100A.

The rectifier unit 91 is, for example, a known voltage multiplier rectifier circuit, an electromagnetic induction coil 12 described below of the power generation unit 10 is connected to its input side, and the wireless module 92A described above is connected to its output side. An induced current induced in the electromagnetic induction coil 12 is rectified by the rectifier unit 91 and applied to the wireless module 92A.

Although a voltage tripler rectifier circuit is illustrated as the rectifier unit 91 in FIG. 1, an n-fold multiplier rectifier circuit according to a desired voltage may be used, and a voltage doubler rectifier circuit is illustrated in the second embodiment.

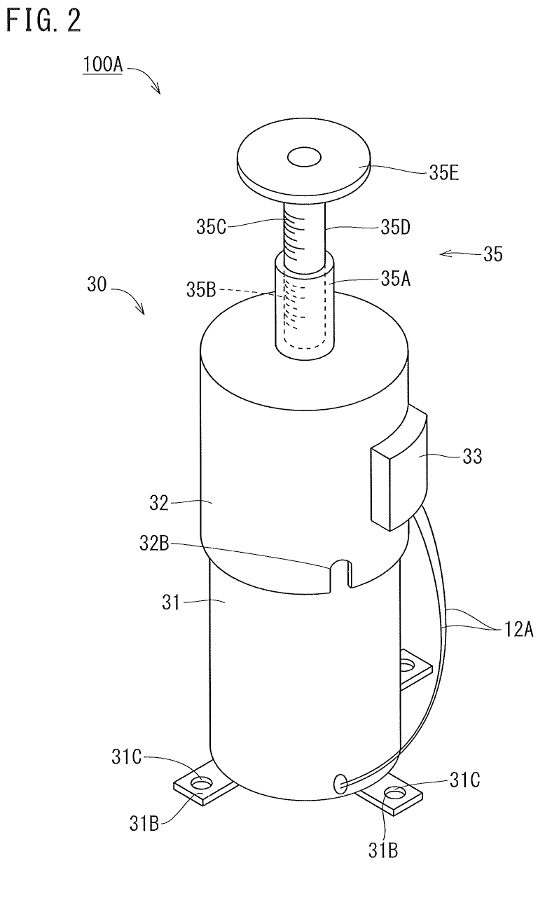

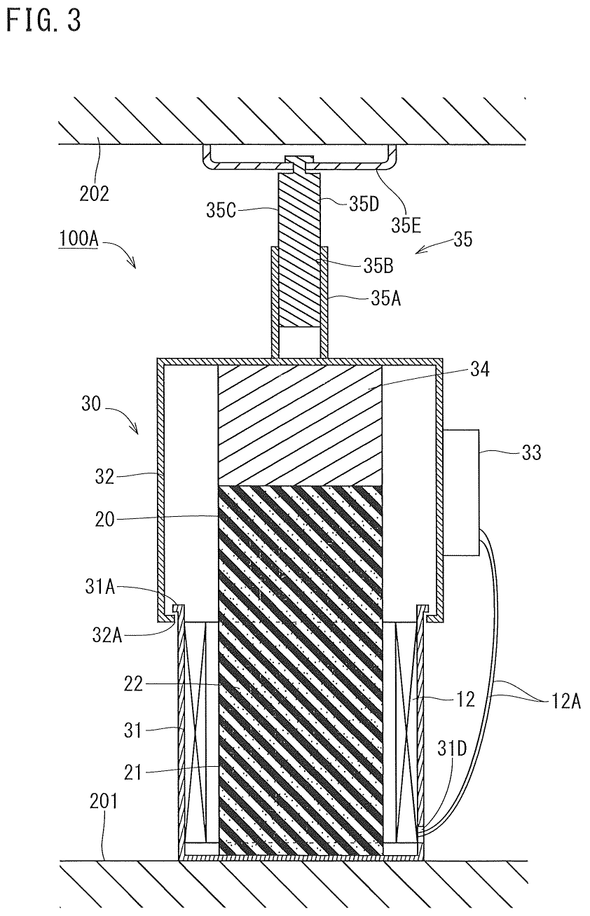

The power generation unit 10 includes the electromagnetic induction coil 12, an elastic body 20 disposed inside the electromagnetic induction coil 12, and a telescopic case 30 that accommodates the electromagnetic induction coil 12 and the elastic body 20. As illustrated in FIGS. 2 and 3, the telescopic case 30 has a structure in which a cylindrical body 31 with one end closed and the other end open and a cylindrical body 32 with one end closed and the other end open having a larger outer diameter than that of the cylindrical body 31 are fitted with the open ends facing each other. In addition, the two cylindrical bodies 31 and 32 have substantially the same axial length, and folded-back portions 31A and 32A that engage with each other to prevent detachment are provided at the open ends of the two cylindrical bodies 31 and 32. The telescopic case 30 changes between a longest state in which the folded-back portions 31A and 32A engage with each other and a shortest state in which the open end of one cylindrical body 31 is in contact with a bottom portion of the other cylindrical body 32. The telescopic case 30 in the shortest state has an axial length of, for example, approximately ½ of the telescopic case 30 in the longest state.

A circuit case 33 accommodating the rectifier unit 91 and the load unit 92 described above is fixed to an outer surface of the cylindrical body 31. In addition, a plurality of protruding pieces 31B protruding laterally from a plurality of positions in the circumferential direction are provided at a side end portion of a bottom wall of the one cylindrical body 31, and an attachment hole 31C is formed in each of the protruding pieces 31B.

Moreover, for example, an adjustment mechanism 35 is provided at a distal end portion of the other cylindrical body 32. The adjustment mechanism 35 includes a support tube 35A protruding from the center of an outer surface of a bottom wall of the cylindrical body 32 and having a female threaded portion 35B on its inner surface, a shaft portion 35D having a male threaded portion 35C on its outer surface to be screwed to the female threaded portion 35B, and a contacting plate 35E that is rotatably attached to a distal end portion of the shaft portion 35D.

The telescopic case 30 of the present embodiment is, for example, a non-magnetic body such as resin or stainless steel. However, the telescopic case 30 and a spacer 34 described later may be formed of a magnetic body such as iron, and the telescopic case 30 may form a magnetic path together with the elastic body 20 described later. In addition, the cylindrical bodies 31 and 32 of the present embodiment are connected to each other in a non-rotatable manner by being connected by the elastic body 20 described later. A vertically long engagement groove may be provided in one of the cylindrical bodies 31 and 32, and a protrusion that engages with the engagement groove may be provided in the other of the cylindrical bodies 31 and 32 to regulate relative rotation between the cylindrical bodies 31 and 32.

As illustrated in FIG. 3, the electromagnetic induction coil 12 has, for example, a cylindrical shape with an outer diameter and an axial length to just fit inside the one cylindrical body 31, and is fixed in the cylindrical body 31. In addition, a pair of lead wires 12A of the electromagnetic induction coil 12 is laterally drawn out of the cylindrical body 31 through a through-hole 31D that passes through a side wall close to the bottom wall of the cylindrical body 31. The pair of lead wires 12A is taken into the circuit case 33 and connected to the rectifier unit 91. The pair of lead wires 12A is bent as the telescopic case 30 extends and contracts. A notch 32B (see FIG. 2) for avoiding interference with the pair of lead wires 12A is formed at an open-side end portion of the cylindrical body 32.

The elastic body 20 has a columnar shape fitted to the inside of the electromagnetic induction coil 12 with a gap therebetween, is disposed coaxially with the telescopic case 30, and has opposite end surfaces fixed to bottom surfaces of the cylindrical bodies 31 and 32 with, for example, an adhesive. In addition, the columnar spacer 34 having the same outer diameter as that of the elastic body 20 is disposed between one end surface of the elastic body 20 and the bottom surface of the cylindrical body 32 as necessary to adjust the compressibility of the elastic body 20. Specifically, in a case where the spacer 34 is not provided, the elastic body 20 in the telescopic case 30 is compressed to ½ similarly to the telescopic case 30 by changing the telescopic case 30 from the longest state to the shortest state. On the other hand, by providing the above spacer 34, the compressibility of the elastic body 20 can be increased to any compressibility of ½ or more.

FIG. 3 illustrates a structure in which the elastic body 20 including the spacer 34 is compressed to ⅓.

The elastic body 20 is slightly compressed between both the bottom surfaces of the cylindrical bodies 31 and 32 in the longest state of the telescopic case 30. This prevents backlash between the cylindrical bodies 31 and 32 in a state where the telescopic case 30 is not subjected to any external force.

The elastic body 20 is fixed to the cylindrical bodies 31 and 32 with an adhesive, but does not have to be fixed. In addition, the bottom surfaces of the cylindrical bodies 31 and 32 and the opposite end surfaces of the elastic body 20 may be provided with recesses and protrusions for centering the elastic body 20 with respect to the telescopic case 30 by the recesses and protrusions being fitted to each other.

The elastic body 20 is, for example, a foamed elastomer in which a magnetized magnetic powder 22 is dispersively disposed. That is, the elastic body 20 is a so-called “magnetic elastic body”. In the following description, in order to clearly distinguish a simple elastic body that is a main body of the elastic body 20 into which the magnetic powder 22 is mixed, from the elastic body 20 including the elastic body and the magnetic powder 22, the entire “elastic body 20” including the elastic body and the magnetic powder 22 is referred to as a “magnetic elastic body 20”, and the simple elastic body, which is a foamed elastomer, is referred to as a foamed elastomer 21.

The foamed elastomer 21 is a polyurethane elastomer foam and has an open-cell structure or a semi-open-cell structure. In addition, the foamed elastomer 21 has an expansion ratio of 1.4 to 6 times. Note that the foamed elastomer 21 may be a rubber foam, a foam of a thermoplastic resin such as a polyolefin-based resin, or the like. In addition, it is preferable that the entire foamed elastomer 21 has an open-cell structure or a semi-open-cell structure from the viewpoint of moldability and elastic deformability, but the foamed elastomer 21 may partially have an open-cell structure or a semi-open-cell structure. In addition, when the foamed elastomer 21 at least partially has an open-cell structure, the foamed elastomer 21 can be inhibited from contracting (so-called shrinking) after being molded. Furthermore, the expansion ratio of the foamed elastomer 21 of the present embodiment is 1.4 to 6 times as described above, but is more preferably 1.7 to 5 times, and still more preferably 2 to 4 times. Here, when the expansion ratio of the foamed elastomer 21 is 1.4 times or more, a particularly favorable cushioning property is obtained, and when the expansion ratio is 6 times or less, particularly favorable moldability and durability are obtained. The above expansion ratio indicates the expansion ratio of the simple foamed elastomer 21, not the expansion ratio of the foamed elastomer 21 containing the magnetic powder 22.

The magnetic powder 22 is a neodymium-based magnetic powder, and the magnetic powder 22 has a particle diameter of 3 to 200 μm. Although it is particularly preferable that the magnetic powder 22 is formed of a neodymium-based magnetic powder having a strong magnetic force when formed into a permanent magnet, the magnetic powder 22 is not limited to the neodymium-based magnetic powder, and may be a known hard magnetic material such as a samarium-based magnetic powder, an alnico-based magnetic powder, or a ferritic magnetic powder. Particles 23 of the magnetic powder 22 are not limited to a particular shape, and specific examples thereof include a scaly shape, a spherical shape, and a needle shape. Furthermore, the particle diameter of the magnetic powder 22 of the present embodiment is 3 to 200 μm as described above, but is more preferably 5 to 100 μm. By increasing the particle diameter of the magnetic powder 22, a surface magnetic flux density of the magnetic elastic body 20 can be increased.

In a case where the magnetic powder 22 is formed by subjecting magnet particles to surface treatment, the proportion of magnetic components in the magnetic powder 22 can be increased by increasing the particle diameter of the magnetic powder 22, and the surface magnetic flux density of the magnetic elastic body 20 can be further increased. In addition, the particle diameter of the magnetic powder 22 is preferably 200 μm or less from the viewpoint of the moldability and deformability of the magnetic elastic body 20. Moreover, when the particle diameter of the magnetic powder 22 is 200 μm or less, the moldability is particularly improved, and the magnetic powder 22 can be further prevented from falling off from the foamed elastomer 21. Furthermore, when the particle diameter of the magnetic powder 22 is less than 3 μm, workability is deteriorated, and thus the particle diameter of the magnetic powder 22 is preferably 3 μm or more. Note that the above particle diameter is measured by a sieving test in accordance with JIS Z 8815:1994.

In the magnetic elastic body 20 of the present embodiment, the magnetic powder 22 has a mass concentration (mass percentage) of 40 to 80% with respect to the foamed elastomer 21, and the magnetic powder 22 has a volume concentration (volume percentage) of 1.0 to 3.5% with respect to the foamed elastomer 21. This makes it possible to increase a change in the magnetic flux density of the magnetic elastic body 20 while facilitating elastic deformation of the magnetic elastic body 20. It is preferable that the magnetic elastic body 20 has a compression set of 30% or less in accordance with JIS K 6262:2013 A method. In addition, it is preferable that the magnetic elastic body 20 has a cyclic compressive strain of 20% or less in a case where 50% compression is repeated 100000 times at 1 Hz. According to such a configuration, restoration after the foamed elastomer 21 is elastically deformed is favorable. As a result, even in a case where the magnetic elastic body 20 is used in an application in which the magnetic elastic body 20 is repeatedly compressed and used, fatigue of the foamed elastomer 21 is reduced, and the magnetic elastic body 20 becomes more suitable for repeated use.

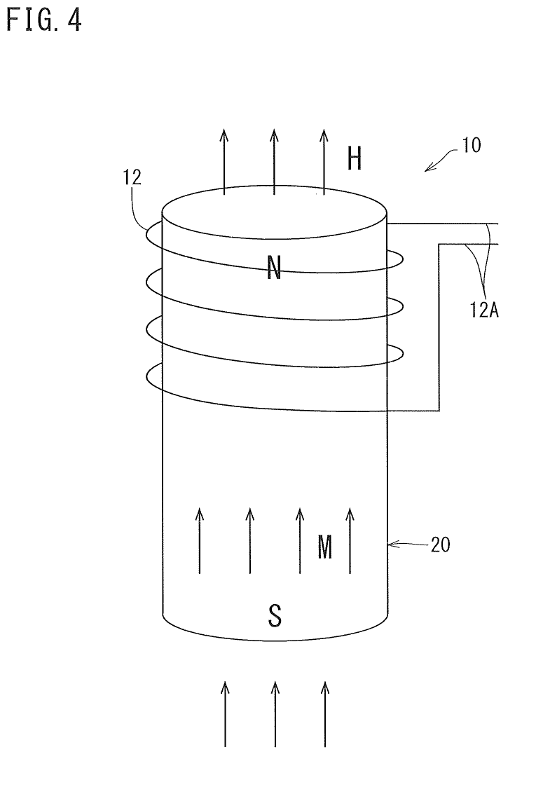

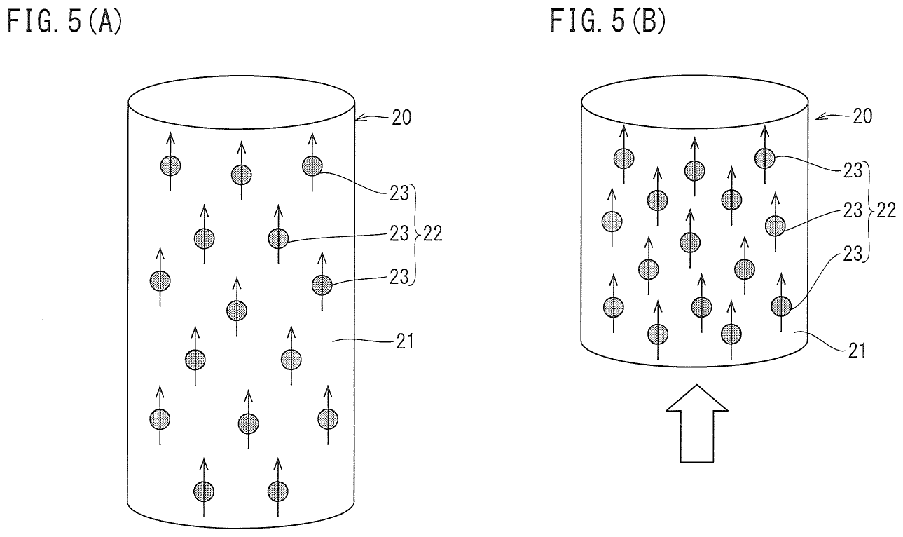

As illustrated in FIG. 5, the particles 23 of the magnetic powder 22 in the foamed elastomer 21 are magnetized such that their magnetic moments (more specifically, a combined magnetic moment in the particles 23) are aligned along the axial direction of the columnar magnetic elastic body 20, whereby one end in the axial direction of the magnetic elastic body 20 becomes an N pole and the other end becomes an S pole as illustrated in FIG. 4. Specifically, the particles 23 of the magnetic powder 22 can include particles whose magnetic moment directions intersect the axial direction of the magnetic elastic body 20, but the direction of the combined magnetic moment obtained by combining the magnetic moments of the particles 23 of the magnetic powder 22 is aligned along the axial direction of the magnetic elastic body 20. In FIG. 5(A) and FIG. 5(B) described later, the magnetization directions of the particles 23 of the magnetic powder 22 are schematically indicated by arrows.

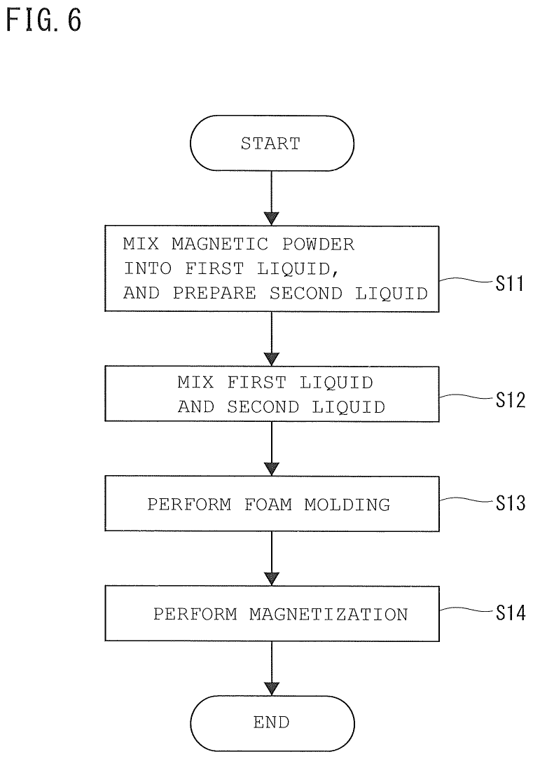

The structure of the electric device 100A has been described above. The electric device 100A is produced by the following method. That is, in order to produce the magnetic elastic body 20 as illustrated in FIG. 6, first, a first liquid obtained by mixing a polyol and an isocyanate to form a prepolymer is prepared. Here, the first liquid is a prepolymer having an isocyanate group (NCO) at its terminal. Thereafter, the magnetic powder 22 is mixed into the first liquid and uniformly dispersed (S11). In addition, a second liquid containing a catalyst, a foaming agent, and the like is prepared (S11). Thereafter, the first liquid and the second liquid are mixed to obtain a mixed liquid (S12). Here, the NCO % of the prepolymer having an isocyanate group at its terminal is preferably 3 to 7%, and is 6% in the present embodiment. This makes it possible to obtain the magnetic elastic body 20 having excellent moldability and durability.

Next, the above mixed liquid is injected into a mold whose temperature is controlled in advance, and foamed and cured to form, for example, a columnar foamed molded body (S13). In this foamed molded body, the magnetic powder 22 is dispersed in the foamed elastomer 21. In addition, in the above foamed molded body, the magnetic moment of each particle 23 of the magnetic powder 22 is directed in a random direction. In the above step of foaming and curing the mixed liquid in the mold, curing (primary curing) is performed in a mold closed state for a predetermined time, and then the obtained foamed molded body is taken out from the mold. The primary curing is performed, for example, at 60 to 120 °C for 10 to 120 minutes. The foamed molded body taken out from the mold after the primary curing is preferably further subjected to secondary curing, and the secondary curing is performed, for example, at 90 to 180 °C for 8 to 24 hours. In the present embodiment, since the elastic member in which the magnetic powder 22 is dispersively disposed is a polyurethane elastomer, the time until the raw material is cured is short, and the raw material can be cured before the magnetic powder 22 precipitates in the raw material. This makes it easy to uniformly disperse the magnetic powder 22. Therefore, even the magnetic powder 22 having a particle diameter of 100 μm or more can be easily dispersed in the magnetic elastic body 20, and the magnetic flux density of the magnetic elastic body 20 can be increased.

In the present embodiment, since the magnetic powder 22 is mixed into the first liquid and then into the second liquid, the magnetic powder 22 can be uniformly dispersed in the foamed elastomer 21 as compared with a case where the magnetic powder 22 is mixed into the second liquid and then into the first liquid.

Next, the above foamed molded body is magnetized (S14). In this step, the magnetic moments of the particles 23 of the magnetic powder 22 in the foamed molded body are aligned by applying an external magnetic field. In the present embodiment, the external magnetic field is applied in the axial direction of the columnar foamed elastomer 21. Here, the magnetization may be performed in a natural length state in which the foamed molded body is not deformed, or may be performed in a state where the foamed molded body is compressed in the axial direction (for example, a 50% compression state in which the foamed molded body is compressed by 50%) with respect to the natural length state. In this manner, the magnetic elastic body 20 is obtained from the foamed molded body.

In addition, it is particularly preferable that the magnetic elastic body 20, when compressed by 10% in the axial direction, has a magnetic flux density (surface magnetic flux density) larger by 5% or more than that in the natural length state. Such a magnetic elastic body 20 can be produced, for example, by magnetizing the magnetic powder 22 in the compression direction in a state where the foamed elastomer 21 in which the magnetic powder 22 is dispersed is compressed (for example, compressed by 50%).

The magnetic elastic body 20 produced as described above is attached to the telescopic case 30 as follows.

The cylindrical bodies 31 and 32 of the telescopic case 30 are prepared in a separated state. The electromagnetic induction coil 12 is fixed to the one cylindrical body 31 in a state where the pair of lead wires 12A of the electromagnetic induction coil 12 is drawn out from the through-hole 31D, and the magnetic elastic body 20 having opposite end surfaces to which an adhesive is applied is disposed inside the electromagnetic induction coil 12 and fixed to both the bottom surfaces of the cylindrical bodies 31 and 32. At this time, the spacer 34 is fixed between one end surface of the magnetic elastic body 20 and the bottom surface of the cylindrical body 32 with an adhesive, as necessary. The one cylindrical body 31 is deformed so as to narrow the open end to be pushed into the other cylindrical body 32, and the one cylindrical body 31 is elastically restored to cause the folded-back portions 31A and 32A of the two cylindrical bodies 31 and 32 to engage with each other.

Next, the pair of lead wires 12A of the electromagnetic induction coil 12 is connected to the rectifier unit 91, the rectifier unit 91 is connected to the load unit 92, and the rectifier unit 91 and the load unit 92 are accommodated in the circuit case 33. The production of the electric device 100A is thus completed.

The method for producing the electric device 100A of the present embodiment has been described above. Next, operational effects of the electric device 100A will be described. As illustrated in FIG. 3, the electric device 100A is set in a gap between a pair of opposing members 201 and 202 whose inter-distance can change, and is used to detect deformation, motion, and the like of the pair of opposing members 201 and 202. For this purpose, the electric device 100A is disposed such that the axial direction of the telescopic case 30 (also the axial direction of the electromagnetic induction coil 12 and the magnetic elastic body 20) is directed in the opposing direction of the pair of opposing members 201 and 202. The adjustment mechanism 35 is adjusted such that the telescopic case 30 is in a desired state, for example, when the inter-distance between the pair of opposing members 201 and 202 is in a normal state. Specifically, in a case where both the cases of separation and approach of the pair of opposing members 201 and 202 from the normal state are to be detected, the adjustment mechanism 35 is adjusted such that the telescopic case 30 is in a compressed state of approximately ½ of the longest state. In addition, in a case where only the approach of the pair of opposing members 201 and 202 from the normal state is to be detected, the adjustment mechanism 35 is adjusted such that the telescopic case 30 is slightly compressed between the pair of opposing members 201 and 202 in the normal state or the contacting plate 35E of the adjustment mechanism 35 is slightly separated from the one opposing member 202. In addition, in order to prevent the electric device 100A from being laterally displaced from the pair of opposing members 201 and 202, it is preferable to fix the telescopic case 30 to one magnetic elastic body 201 by fastening a bolt inserted through the attachment hole 31C of the telescopic case 30 to a threaded hole of the one magnetic elastic body 201 as necessary.

When the distance between the pair of opposing members 201 and 202 changes in a state where the electric device 100A is set between the pair of opposing members 201 and 202 as described above, the magnetic elastic body 20 is extended and contracted in the axial direction together with the telescopic case 30. Then, the density of the magnetic flux passing through the electromagnetic induction coil 12 in the magnetic flux of a magnetic field by the magnetic elastic body 20 changes to generate an induced current I. That is, the power generation unit 10 generates electric power.

The mechanism by which the power generation is performed is considered as follows. That is, in the axial direction of the electromagnetic induction coil 12, when the magnetic flux density in the magnetic elastic body 20 is Bz, the external magnetic field is Hz, the magnetization of the magnetic elastic body 20 is Mz, and the magnetic permeability of vacuum is μ0, it is known that the following relationship holds.

Bz=μ0·Hz+Mz (A)

In addition, with respect to the magnetization Mz, when the average value of the magnetic moments of the particles 23 of the magnetic powder 22 in the axial direction of the electromagnetic induction coil 12 is mz, and the number of particles 23 of the magnetic powder 22 per unit volume of the magnetic elastic body 20 is n, it is known that the following relationship holds.

Mz=n·mz (B)

Here, since the magnetic elastic body 20 is formed by mixing the magnetic powder 22 into the foamed elastomer 21, the bubbles of the foamed elastomer 21 are squeezed when the magnetic elastic body 20 is compressed in the axial direction, and the bubbles expand when the magnetic elastic body 20 is extended, so that the magnetic elastic body 20 extends and contracts in a state where a change in the radial size is suppressed. When the magnetic elastic body 20 is compressed in the axial direction of the electromagnetic induction coil 12 (FIG. 5(B)), it is considered that a distribution density of the particles 23 of the magnetic powder 22 in the magnetic elastic body 20 increases (that is, n in the relational formula (B) increases), and the magnetization Mz increases. When the magnetic elastic body 20 is extended, it is considered that the magnetization Mz decreases.

In particular, in a case where the magnetic elastic body 20 is magnetized in a compressed state in which the magnetic elastic body 20 contracts with respect to the natural length state, when the magnetic elastic body 20 is compressed in the axial direction of the electromagnetic induction coil 12, the directions of the magnetic moments of the particles 23 of the magnetic powder 22 are more aligned in the axial direction of the electromagnetic induction coil 12 as compared with the natural length state. Thus, it is considered that the average value mz of the magnetic moments increases.

In addition to the effect of the change in the distribution density of the magnetic powder 22 described above, it is considered that the amount of change in the magnetization Mz further increases as the average value mz of the magnetic moments increases and decreases. Specifically, when the magnetic elastic body 20 is compressed to reach the vicinity of the compression amount at the time of magnetization (that is, the compression amount when the directions of the magnetic moments mz of the magnetic powder 22 are most aligned in the axial direction of the magnetic elastic body 20), the magnetization Mz is considered to be particularly large.

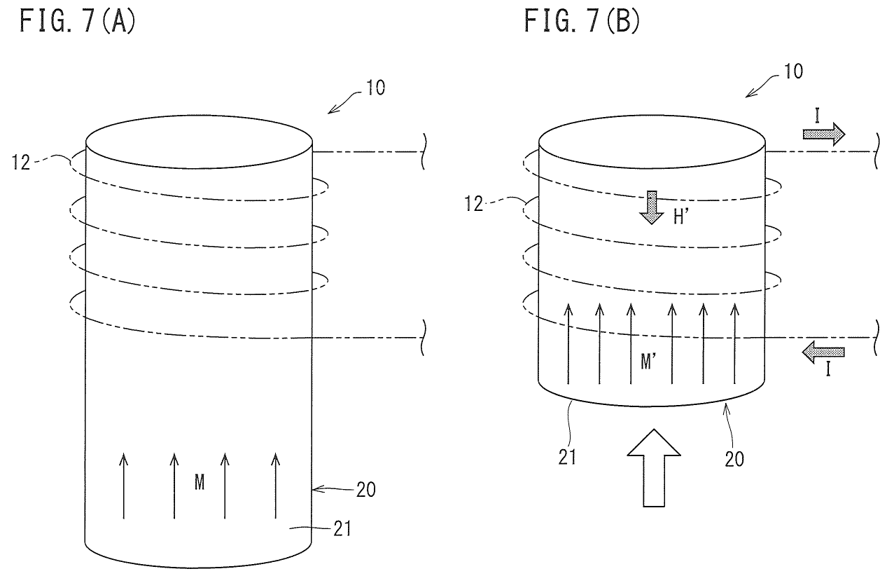

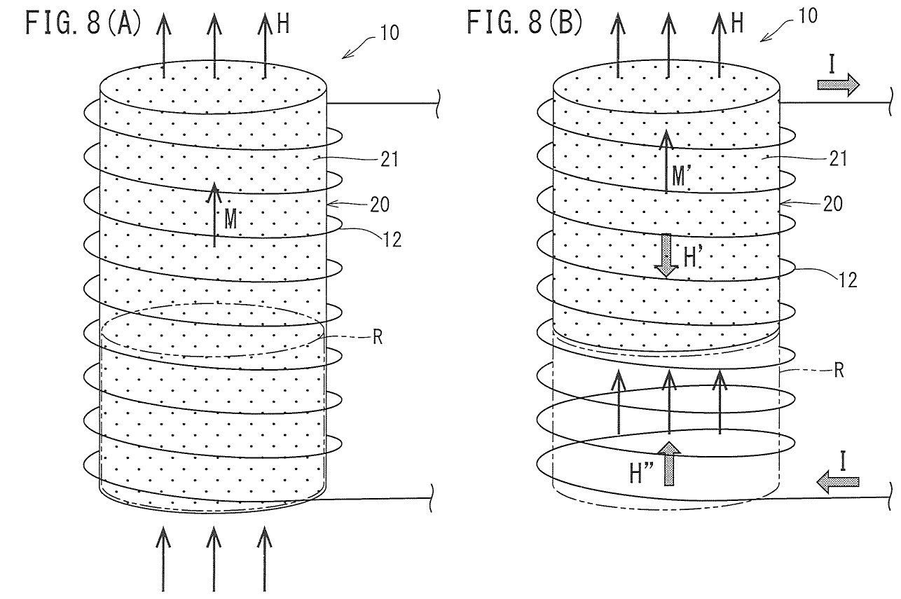

As the magnetization Mz increases, the magnetic flux density Bz in the magnetic elastic body 20 increases according to the above relational formula (A), so that the magnetic flux passing through the electromagnetic induction coil 12 increases. In a case where the magnetic elastic body 20 is extended, a phenomenon opposite to that in the case where the magnetic elastic body 20 is compressed occurs. It is considered that the induced current I flows through the electromagnetic induction coil 12 so as to generate a magnetic field H′ in a direction (downward in FIG. 7) to cancel out the change in the magnetic flux. In FIGS. 7 and 8, the induced current I and the magnetic field H′ generated by the induced current I are indicated by gray arrows.

FIGS. 8(A) and 8(B) illustrate an example of a case where the size of a portion of the magnetic elastic body 20 disposed in the electromagnetic induction coil 12 changes due to the deformation of the magnetic elastic body 20. In this case, as described below, it is considered that the magnetic flux passing through the electromagnetic induction coil 12 changes also due to a factor other than the change in the magnetization of the magnetic elastic body 20.

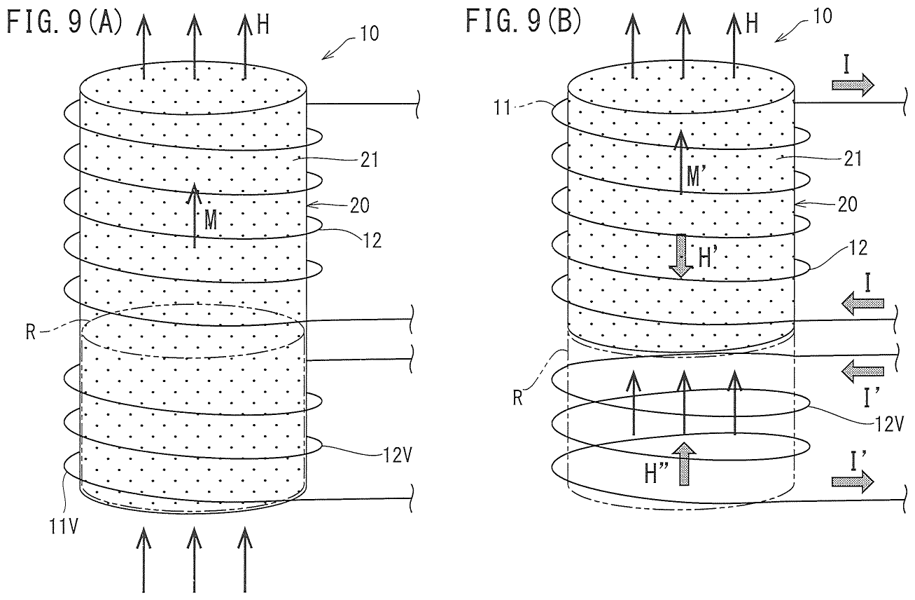

In the example of FIGS. 8(A) and 8(B), the magnetic elastic body 20 is compressed in the axial direction of the electromagnetic induction coil 12. In this case, the electromagnetic induction coil 12 is provided therein with a region R where the magnetic elastic body 20 is present before the deformation (FIG. 8(A)) of the magnetic elastic body 20, and the magnetic elastic body 20 is not present after the deformation (FIG. 8(B)). In this region R, the magnetic flux changes before and after the deformation of the magnetic elastic body 20. Thus, it is considered that a magnetic field H″ is generated in the region R so as to cancel out the change in the magnetic flux. The direction of the magnetic field H″ can be opposite to that of the magnetic field H′ due to the change in the distribution density of the particles 23 of the magnetic powder 22 in the magnetic elastic body 20 described above. However, since these magnetic fields do not always have the same magnitude during the deformation of the magnetic elastic body 20, it is considered that a change in the magnetic flux passing through the electromagnetic induction coil 12 occurs and the induced current I can be generated in the electromagnetic induction coil 12. In a case where the magnetic field H′ and the magnetic field H″ directed opposite to each other are generated as described above, an electromagnetic induction coil 12V surrounding the region R may be disposed as illustrated in FIG. 9. By generating the induced current generated by the magnetic field H′ and the induced current generated by the magnetic field H″ in different circuits in this manner, it is possible to prevent the two induced currents from being canceled out. Note that the case where the magnetic elastic body 20 is extended is similar to the case where the magnetic elastic body 20 is compressed.

As described above, the induced current I generated in the power generation unit 10 is rectified by the rectifier unit 91 and received by the load unit 92. Then, the wireless module 92A of the load unit 92 outputs a wireless signal including information of the identification number. As a result, a wireless terminal located away from the electric device 100A can receive the wireless signal from the electric device 100A and monitor a load applied to the pair of opposing members 201 and 202 or the behavior.

It is possible to monitor the behavior of an elevated bridge or a building due to a typhoon, an earthquake, and the like, the presence or absence of abnormality, and the like by setting a plurality of the electric devices 100A of the present embodiment in a gap between a bridge girder and a bridge body of the elevated bridge, a gap under a floor of the building having a base isolation structure, a gap under a road surface of a road, and the like, storing installation places and identification numbers of the electric devices 100A in association with each other, and monitoring wireless signals from the plurality of electric devices 100A by a monitoring terminal.

As described above, the electric device 100A of the present embodiment changes the magnetic flux density of the magnetic field passing through the electromagnetic induction coil 12 by the deformation of the magnetic elastic body 20 to perform self-power generation by electromagnetic induction, so that the structure related to the power generation can be simplified as compared with an electric device that generates electric power by a conventional rotary machine.

In addition, since the magnetic elastic body 20 is the foamed elastomer, the magnetic elastic body 20 can be extended and contracted with a larger stroke as compared with a case where the magnetic elastic body is formed of an elastic body such as a typical resin including a non-foamed elastomer or a metal. Since the magnetic elastic body 20 can generate electric power by changing the magnetic flux density by deformation with a large stroke, the amount of power generation per stroke can be increased as compared with a magnetic elastic body in which the magnetic flux density can be changed only with a short stroke. In addition, assume that the same amount of power generation as that can be generated by the change of the magnetic flux only with a short stroke is obtained, it is possible to perform power generation in which the direction of the magnetic flux is reversed in a long period. That is, the power generation unit 10 included in the electric device 100A of the present embodiment can generate a low-frequency alternating current, which facilitates impedance matching between the power generation unit 10 and the rectifier unit 91, the load unit 92, and the like connected thereto. Furthermore, since the magnetic elastic body 20 can suppress the change in the radial size along with the extension and contraction as described above, interference with the electromagnetic induction coil 12 can be suppressed, and a clearance between the magnetic elastic body 20 and the electromagnetic induction coil 12 disposed on its outer side can be narrowed to increase the power generation efficiency. In addition, since the magnetic elastic body 20 is the foamed elastomer, the magnetic elastic body 20 is difficult to damage and easy to handle.

### Second Embodiment

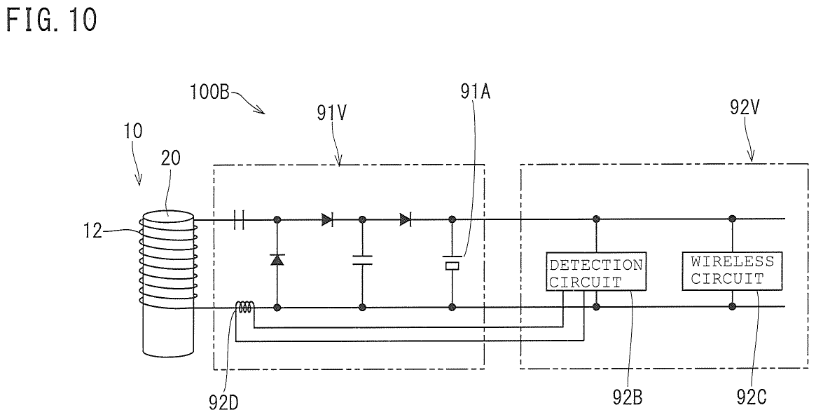

An electric device 100B of the present embodiment is illustrated in FIG. 10, and is different from the first embodiment in the configurations of a rectifier unit 91V and a load unit 92V. That is, the rectifier unit 91V is a voltage doubler rectifier circuit, and a secondary battery 91A is connected between a pair of output terminals of the rectifier unit 91V. In addition, the load unit 92V includes a detection circuit 92B and a wireless circuit 92C, and a current detection unit 92D for detecting an induced current flowing through the electromagnetic induction coil 12 is connected to the load unit 92V. Furthermore, the detection circuit 92B includes an A/D converter and a microcomputer. Detection data for specifying an external force received by the electric device 100B is generated on the basis of the induced current generated by the electromagnetic induction coil 12, and the detection data is wirelessly transmitted by the wireless circuit 92C. Examples of the detection data include various data such as FFT data and spectrum data of the induced current, and data of a peak value included in the waveform of the induced current.

In the electric device 100B of the present embodiment, since the detection data for specifying the external force is generated on the basis of the induced current generated by the power generation unit 10 and then wirelessly transmitted, it is possible to collect data that is hardly affected by noise due to wireless transmission at a remote value away from the electric device 100B. In addition, since the secondary battery 91A is provided, power supply to the load unit 92V is stabilized.

### Third Embodiment

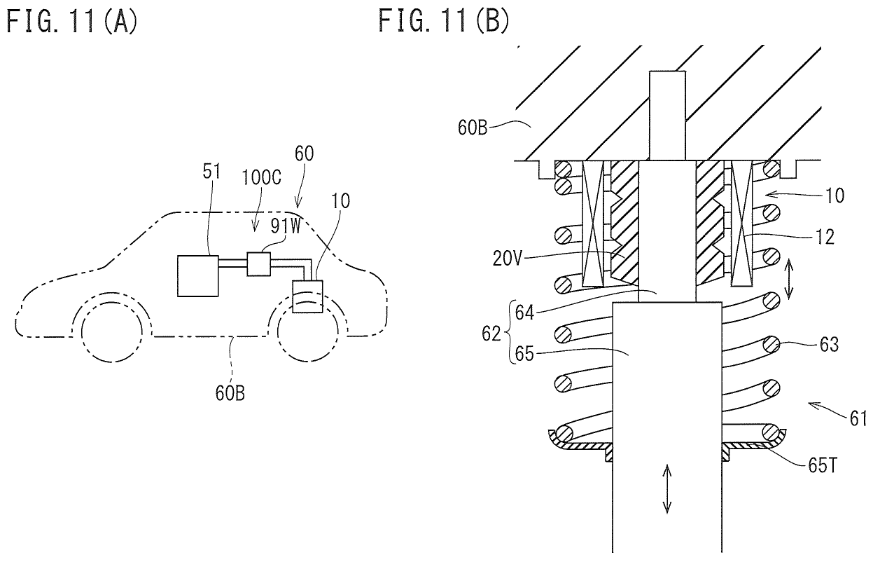

An electric device 100C of the third embodiment of the present disclosure is illustrated in FIG. 11, and is mounted on a vehicle 60 to charge a battery 51 of the vehicle 60. Hereinafter, only configurations different from the first and second embodiments will be described.

The power generation unit 10 of the electric device 100C of the present embodiment is attached to a suspension 61 of the vehicle 60. As illustrated in FIG. 11(B), the suspension 61 of the vehicle 60 includes a shock absorber 62 and a suspension spring 63. The suspension spring 63 is sandwiched between a flange-shaped portion 65T protruding outward from a cylinder 65 of the shock absorber 62 and a vehicle body 60B. A magnetic elastic body 20V included in the power generation unit 10 of the electric device 100C has a tubular shape and is fitted to a piston rod 64 of the shock absorber 62 to function as a bound stopper. That is, when the shock absorber 62 contracts, the magnetic elastic body 20V is compressed between the cylinder 65 and the vehicle body 60B to reduce the bound of the vehicle 60.

The electromagnetic induction coil 12 of the power generation unit 10 of the electric device 100C is disposed so as to surround the magnetic elastic body 20V inside the suspension spring 63, and its upper end portion is fixed to the vehicle body 60B. When the magnetic elastic body 20V extends and contracts, an induced current flows through the electromagnetic induction coil 12 to generate electric power.

A rectifier unit 91W of the electric device 100C boosts the electric power generated by the power generation unit 10 to a voltage necessary for charging the battery 51. The output of the power generation unit 10 is applied to the battery 51 corresponding to the load unit of the electric device 100C through the rectifier unit 91W to charge the battery 51.

Although an automobile is exemplified as the vehicle 60 in the above embodiment, the present disclosure may be applied, for example, to a vehicle suspension of a two-wheeled vehicle, a train, and the like. In addition, examples of the automobile include electric vehicles such as an electric car, a hybrid car, and a plug-in hybrid car.

### Fourth Embodiment

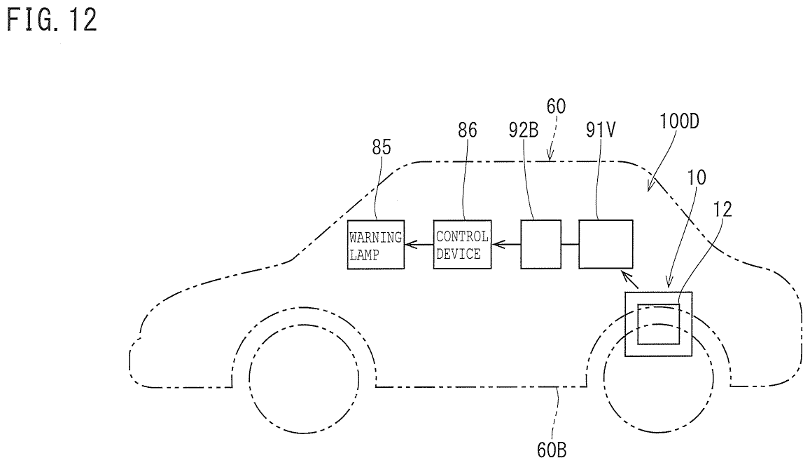

An electric device 100D of the fourth embodiment is illustrated in FIG. 12, and includes the power generation unit 10 similar to that of the electric device 100C of the third embodiment, and the rectifier unit 91V and the detection circuit 92B as the load unit similar to those of the electric device 100B of the second embodiment. Detection data generated by the detection circuit 92B is given to a control device 86 of the vehicle 60. The control device 86 determines the presence or absence of abnormality such as overloading of the vehicle 60 or a failure of the suspension 61 on the basis of the given detection data, and turns on a warning lamp 85 to notify a driver of the abnormality in the presence of the abnormality.

In the above embodiment, the vehicle 60 includes the electric device 100D, and the abnormality related to the vehicle 60 is detected. However, for example, the above electric device 100D may be provided in a tank or a pipe in a plant, and the abnormality of the tank or the pipe may be detected.

### Fifth Embodiment

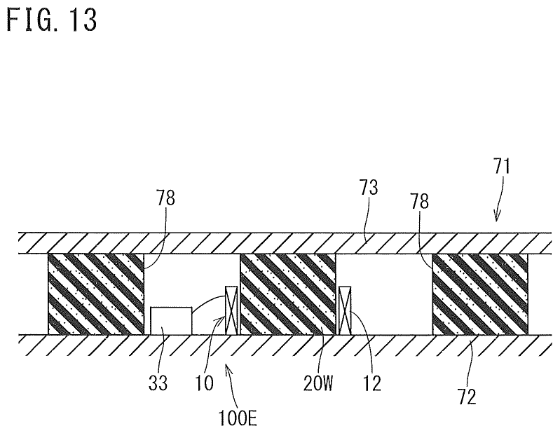

An electric device 100E of the present embodiment is illustrated in FIGS. 13(A) and 13(B), and is incorporated in a floor structure 71 of a building or a vehicle. Specifically, the floor structure 71 has a structure in which a floor panel 73 is laid above a base 72, and a plurality of cushioning materials 78 are laid between the base 72 and the floor panel 73. When a load is applied to the floor panel 73, the cushioning materials 78 are elastically deformed. One or some of the plurality of cushioning materials 78 are magnetic elastic bodies 20W, and the electromagnetic induction coil 12 is provided so as to surround the magnetic elastic body 20W. In addition, the electric device 100E includes the rectifier unit and the wireless module similar to those of the first embodiment, which are accommodated in the circuit case 33.

### Sixth Embodiment

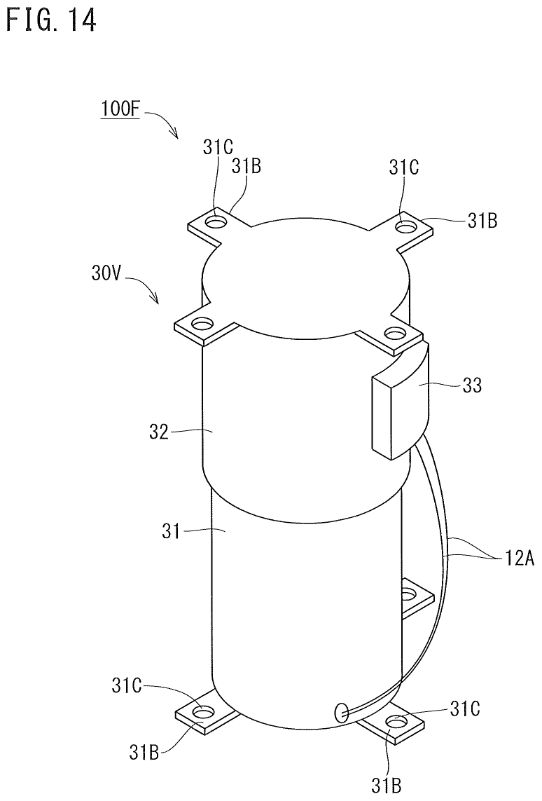

An electric device 100F of the present embodiment is illustrated in FIG. 14, and the magnetic elastic body 20 is torsionally deformed by receiving an external force. Specifically, the electric device 100F has a structure in which a twist case 30V formed by removing the adjustment mechanism 35 from one cylindrical body 32 of the telescopic case 30 of the electric device 100A of the first embodiment and including the plurality of protruding pieces 31B similar to those of the other cylindrical body 32 includes the magnetic elastic body 20 and the electromagnetic induction coil 12 having the same shapes as those of the magnetic elastic body 20 and the electromagnetic induction coil 12 of the electric device 100A of the first embodiment. The twist case 30V is attached between a pair of relatively rotating members or to the middle of a shaft that receives load torque. As a result, the pair of cylindrical bodies 31 and 32 relatively rotate by receiving an external force as the load torque, and the magnetic elastic body 20 is twisted. In addition, the magnetic elastic body 20 is disposed in a magnetic field directed in the axial direction of the magnetic elastic body 20 in the torsionally deformed state, for example, and the magnetic powder 22 is magnetized. Other structures are similar to those of the electric device 100A of the first embodiment.

In the electric device 100F, when the magnetic elastic body 20 is torsionally deformed in one direction, the directions of the magnetic moments of the magnetic powder 22 of the magnetic powder 22 are aligned in a direction passing through the electromagnetic induction coil 12, and when the magnetic elastic body 20 is torsionally deformed in the other direction, the directions of the magnetic moments of the magnetic powder 22 are aligned in a direction different from the direction passing through the electromagnetic induction coil 12 or become random. As a result, the density of the magnetic flux passing through the electromagnetic induction coil 12 changes along with the torsional deformation of the magnetic elastic body 20, the power generation unit 10 generates electric power, and the wireless module 92A of the load unit 92 receives the electric power to transmit a wireless signal.

### Seventh Embodiment

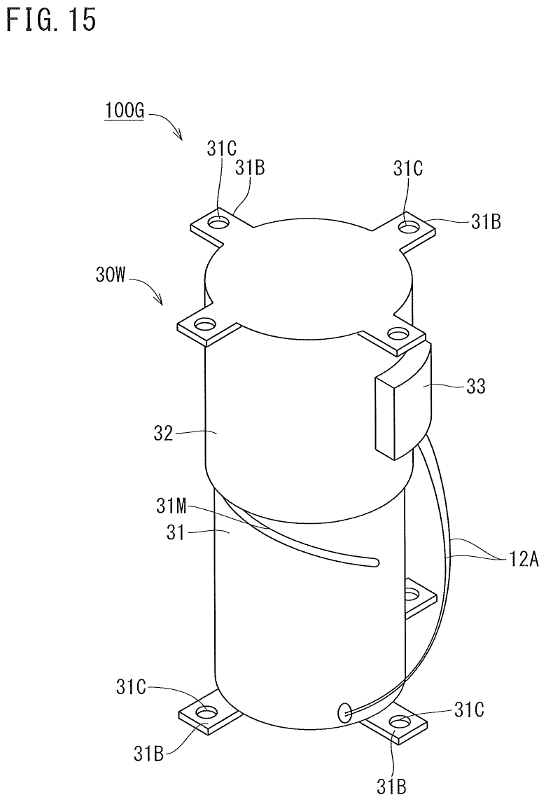

An electric device 100G of the present embodiment is illustrated in FIG. 15, and includes a twist case 30W in which a screwing mechanism is added to the twist case 30V of the electric device 100F of the sixth embodiment. Specifically, an outer surface of one cylindrical body 31 of the twist case 30W is provided with an engagement portion 31M having a groove structure or a ridge structure extending in a spiral shape, and an inner surface of the other cylindrical body 32 is provided with an engagement portion (not illustrated) to be screwed with the engagement portion 31M. As a result, when the cylindrical bodies 31 and 32 of the twist case 30W relatively rotate, the magnetic elastic body 20 is torsionally deformed as well as being deformed to extend and contract. As a result, an induced current is induced in the electromagnetic induction coil 12.

### Eighth Embodiment

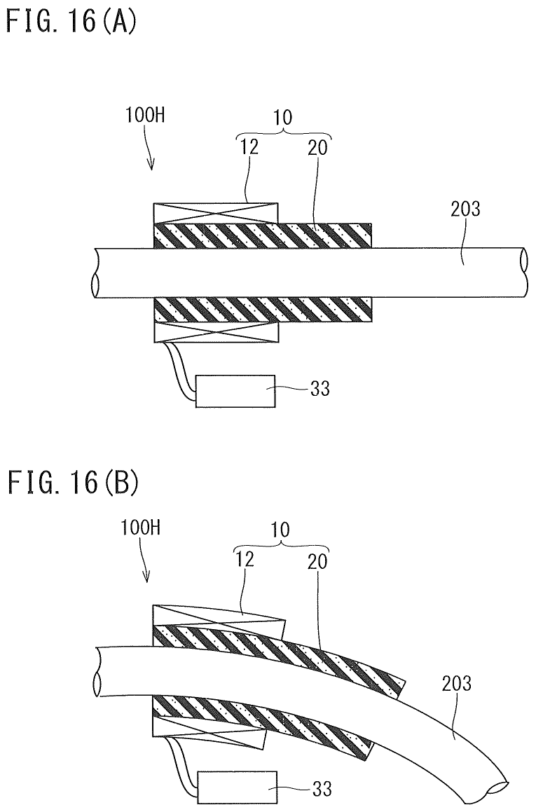

An electric device 100H of the present embodiment is illustrated in FIG. 16. As illustrated in FIG. 16(A), the power generation unit 10 of the electric device 100H includes the cylindrical magnetic elastic body 20 exactly fitted to a shaft 203 as a target whose bending deformation is to be detected, and the electromagnetic induction coil 12 fitted to the outside of the magnetic elastic body 20. As illustrated in FIG. 16(B), the magnetic elastic body 20 and the electromagnetic induction coil 12 are bent and deformed together with the shaft 203. In addition, the electric device 100H includes, for example, the rectifier unit 91 and the wireless module 92A similar to those of the electric device 100A of the first embodiment, which are accommodated in the circuit case 33. When the magnetic elastic body 20 is bent and deformed along with the bending deformation of the shaft 203, the density of the magnetic flux passing through the electromagnetic induction coil 12 changes, the power generation unit 10 generates electric power, and the wireless module 92A of the load unit 92 receives the electric power to transmit a wireless signal.

### Ninth Embodiment

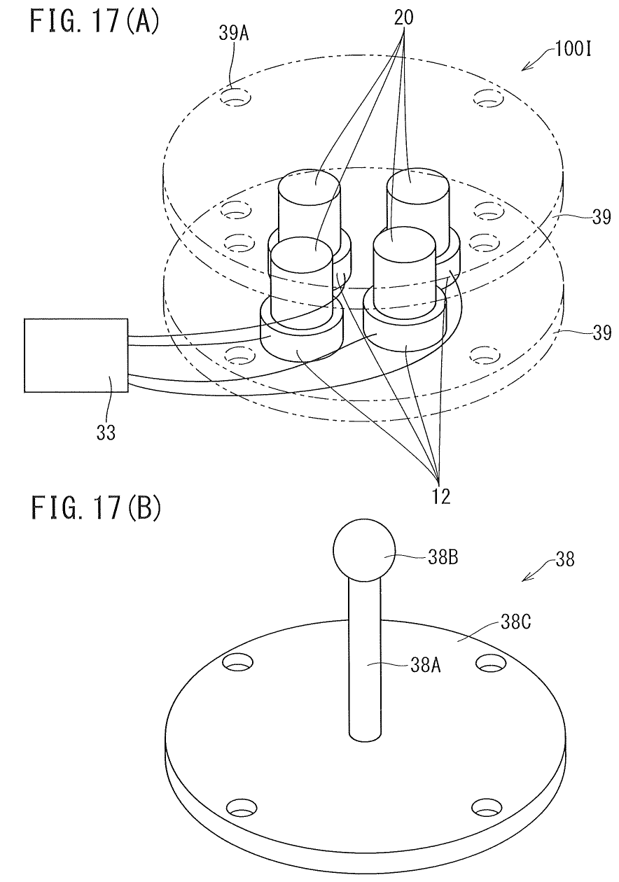

An electric device 100I of the present embodiment is illustrated in FIG. 17(A), and has a structure in which a pair of non-magnetic disks 39 is provided facing each other, and a plurality of the magnetic elastic bodies 20 are connected in parallel between the pair of disks 39. Specifically, the plurality of magnetic elastic bodies 20 have, for example, a columnar shape, and in a portion inner from outer edge portions of the pair of disks 39, the central axes of the magnetic elastic bodies 20 are disposed at positions dividing an imaginary circle concentric with the central axis of the pair of disks 39 into a plurality of equal parts, and each magnetic elastic body 20 is fixed to the pair of disks 39 with an adhesive applied to the opposite end surfaces of each magnetic elastic body 20. A plurality of attachment holes 39A are formed in the outer edge portions of the pair of disks 39.

In addition, the electromagnetic induction coil 12 is fitted to the outside of each magnetic elastic body 20. A plurality of the rectifier units 91 and the wireless modules 92A described in the first embodiment are provided corresponding to the plurality of electromagnetic induction coils 12, and are accommodated in the circuit case 33. Every time an induced current of a predetermined magnitude abnormality flows through each electromagnetic induction coil 12, the wireless module 92A corresponding to each electromagnetic induction coil 12 transmits a wireless signal including information of an identification number unique to the wireless module 92A.

The electric device 100I of the present embodiment is used with the pair of disks 39 fixed to a detection target. The plurality of electromagnetic induction coils 12 generate electric power according to a behavior in which the pair of disks 39 approaches or separates from each other, a behavior in which one of the disks 39 tilts in any direction with respect to the other disk 39, or a behavior in which one of the disks 39 rotates about the central axis with respect to the other disk 39, and a wireless signal according to the power generation state is output.

In addition, as illustrated in FIG. 17(B), an additional component 38 in which a support column 38A is erected from a center portion of a disk 38C and a mass 38B is provided at a distal end portion of the support column 38A is prepared. The disk 38C of the additional component 38 is stacked on and fixed to one of the disks 39 of the electric device 100I, and the other disk 39 is fixed to a building, a vehicle, a ground, or the like, so that vibration or the like received by the electric device 100I can be detected.

### Confirmation Experiment

It has been experimentally confirmed that power generation is performed by the electromagnetic induction coil 12 and the magnetic elastic body 20 described in the first embodiment. Specifically, an induced electromotive force generated in the electromagnetic induction coil 12 has been confirmed as a substitute value of the induced current I.

### I. Configuration of Electromagnetic Induction Device

As the electromagnetic induction coil 12, one formed of a copper wire and having a coil winding diameter (inner diameter) of 36 mm (36Φ), an axial length of 70 mm, a wire diameter of 0.5 mm, the number of windings of 1395, and a resistance of 13Ω was used. As the magnetic elastic body 20, one obtained by dispersing the neodymium-based magnetic powder in the foamed elastomer 21 of polyurethane was used. The neodymium-based magnetic powder used had different particle diameters (5 μm and 100 μm). The magnetic elastic body 20 has a columnar shape, and the magnetic elastic body 20 has a diameter of 23 mm and an axial length of 23 mm. A magnetization condition of the magnetic elastic body 20 was 8 teslas for 3 seconds. The magnetization of the magnetic elastic body 20 was performed in the natural length state and the 50% compression state in the axial direction. In this experiment, the magnetic elastic body 20 was disposed coaxially with the electromagnetic induction coil 12, and the magnetic elastic body 20 was disposed such that its center position coincided with that of the electromagnetic induction coil 12 in the natural length state. The magnetic elastic body 20 was disposed to be entirely within the electromagnetic induction coil 12 such that the axial direction coincided with the vertical direction, and was compressed from one end side (from below) in the axial direction to be elastically deformed.

### II. Details of Magnetic Elastic Body of Each Experimental Example

Details of the raw material of the magnetic elastic body 20 are as follows.

### (1) First Liquid

Polyol; Polyester polyol (molecular weight: 2000, number of functional groups: 2, hydroxyl value: 56 mgKOH/g, product name: “POLYLITE OD-X-102”, manufactured by DIC Corporation
Isocyanate; 1,5-naphthalene diisocyanate (NC 0%: 40%, product name: “COSMONATE ND”, manufactured by Mitsui Chemicals, Inc.)
Neodymium-based magnetic powder; (1) MQFP (5 μm), manufactured by Magnequench International, LLC, (2) MQFP (100 μm), manufactured by Magnequench International, LLC

### (2) Second Liquid

Catalyst; Amine catalyst, product name: “Addocat PP”, manufactured by Rhein Chemie Japan Ltd.
Foaming agent; Mixed liquid containing castor oil and water, product number: “ADDOVATE SV” (weight ratio of castor oil to water: 50:50), manufactured by Rhein Chemie Japan Ltd.

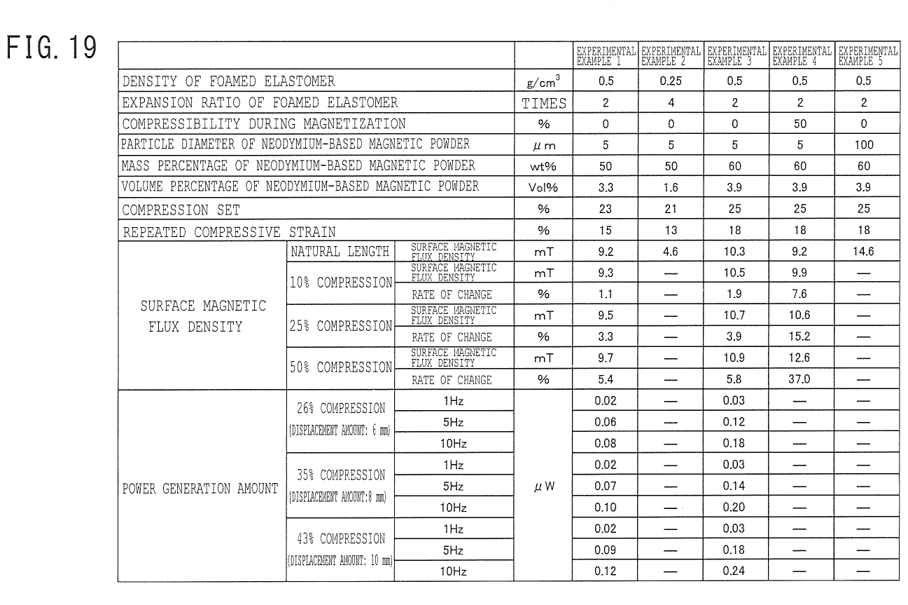

In this experiment, the magnetic elastic bodies 20 having different expansion ratios of the foamed elastomer 21, different mixing ratios and particle diameters of the neodymium-based magnetic powder, and different magnetization methods were used (Experimental Examples 1 to 5). The magnetization conditions, property values, and the like in the magnetic elastic bodies 20 of the respective experimental examples are as shown in FIG. 19.

FIG. 19 shows the details and properties of the foamed elastomers of Experimental Examples 1 to 5. In Experimental Example 1, the foamed elastomer 21 is magnetized in the natural length state at an expansion ratio of 2 times, and the neodymium-based magnetic powder has a particle diameter of 5 μm, a mass percentage of 50% by mass, and a volume percentage of 3.3% by volume. Experimental Example 2 is the same as Experimental Example 1 except that the expansion ratio of the foamed elastomer 21 is 4 times and the volume percentage of the neodymium-based magnetic powder is 1.6% by volume. Experimental Example 3 is the same as Experimental Example 1 except that the mass percentage of the neodymium-based magnetic powder is 60% by mass and the volume percentage is 3.9% by volume. Experimental Example 4 is the same as Experimental Example 3 except that magnetization is performed in the 50% compression state in the axial direction. Experimental Example 5 is the same as Experimental Example 3 except that the particle diameter of the neodymium-based magnetic powder is 100 μm.

### III. Test Methods

(1) Density and Expansion ratio of foamed elastomer

For the expansion ratio of the foamed elastomer 21, a test sample of the columnar magnetic elastic body 20 having a diameter of 23 mm and an axial length (thickness) of 23 mm was prepared from the first liquid and the second liquid not containing the neodymium-based magnetic powder, the density was measured in accordance with JIS K6268:1998, and the expansion ratio was calculated from this density.

### (2) Mass Percentage and Volume Percentage of Neodymium-Based Magnetic Powder

The mass percentage of the neodymium-based magnetic powder was obtained by measuring the mass of the neodymium-based magnetic powder with respect to the mass of the first liquid using a balance. The volume percentage of the neodymium-based magnetic powder was calculated from the mass percentage of the neodymium-based magnetic powder, the density of the neodymium-based magnetic powder, and the density of the foamed elastomer 21 using the following formula. Here, the density of the neodymium-based magnetic powder was 7.6 g/cm3.

Volume percentage (%) of neodymium-based magnetic powder=(mass percentage of neodymium-based magnetic powder×density of foamed elastomer)/(density of neodymium-based magnetic powder)

### (3) Compression Set

A test sample of the magnetic elastic body 20 having a diameter of 13 mm and a thickness of 6.3 mm was prepared, and the compression set was measured in accordance with JIS K 6262:2013 A method (small test piece 70 °C×22 hours, 25% compression).

### (4) Cyclic Compressive Strain

For a test sample of the magnetic elastic body 20 having a diameter of 23 mm and an axial length (thickness) of 23 mm, 50% compression in the axial direction from the natural length state (original thickness) was performed 100000 times at 1 Hz (1 time/second), the amount of change in the thickness before and after the cyclic compression tests was measured, and the cyclic compressive strain was calculated from the following calculation formula. This measurement was performed at normal temperature (23 °C).

Cyclic compressive strain (%)=(thickness before compression test−thickness after compression test)/(thickness before compression test)×100

### (5) Surface Magnetic Flux Density

The surface magnetic flux density was obtained by preparing a test sample of the magnetic elastic body 20 having a diameter of 23 mm and an axial length (thickness) of 23 mm, measuring the magnetic flux density at the center of each of the upper surface and the lower surface as the opposite end surfaces in the axial direction 10 times (20 times in total) using a Gauss meter (“MG-601”, manufactured by Magna Co., Ltd.) , and calculating the average value. In addition, the surface magnetic flux density was measured for the magnetic elastic body 20 in the natural length state and the compression state compressed by 10%, 25%, and 50% from the natural length state in the axial direction, and the rate of change in the surface magnetic flux density in each compression state with respect to the natural length state was calculated.

### (6) Power Generation Amount

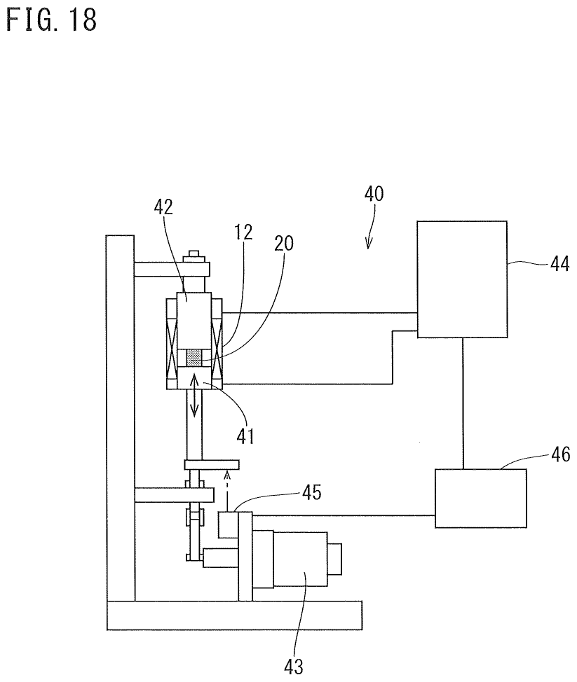

The amount of power generation was evaluated by vibrating and deforming the magnetic elastic body 20 so as to repeat compression and restoration in the axial direction of the electromagnetic induction coil 12 and measuring a voltage between the opposite ends of the electromagnetic induction coil 12 by a testing apparatus 40 illustrated in FIG. 18. The vibration deformation of the magnetic elastic body 20 was performed under 9 conditions including a combination of 3 levels of compressibility (stroke amount) and 3 levels of frequency, and the above voltage was measured for each condition. Specifically, the level of amplitude is 6 mm, 8 mm, and 10 mm (displacement amount), and the level of frequency is 1 Hz, 5 Hz, and 10 Hz.

Details of the testing apparatus 40 are as follows. The testing apparatus 40 includes a piston 41 and a fixing member 42 that sandwich the magnetic elastic body 20 in the axial direction of the electromagnetic induction coil 12 inside the electromagnetic induction coil 12. The piston 41 receives power from a drive source 43 and vibrates in the axial direction of the electromagnetic induction coil 12 to vibrate and deform the magnetic elastic body 20. A distance between the fixing member 42 and the piston 41 is set to the same length as the natural length of the magnetic elastic body 20 when the piston 41 moves farthest from the fixing member 42 in the stroke of vibration. That is, in this experiment, the fixing member 42 and the piston 41 are always in contact with the magnetic elastic body 20.

The opposite ends of the electromagnetic induction coil 12 are connected to an oscilloscope 44, and the oscilloscope 44 displays an induced electromotive force generated in the electromagnetic induction coil 12. Furthermore, the testing apparatus 40 is provided with a laser displacement meter 45 for detecting the vibration of the piston 41. The laser displacement meter 45 outputs a signal related to the amplitude, frequency, and the like of the piston 41 to the oscilloscope 44 through an amplifier unit 46, and the amplitude and frequency of the vibration of the piston 41 can be checked on the oscilloscope 44.

### IV. Test Results

Since the foamed elastomer 21 is a polyurethane elastomer in all of Experimental Examples 1 to 5, favorable results are obtained where the compression set is 21 to 25% and the cyclic compressive strain is 13 to 18%.

The surface magnetic flux densities in the natural length state of Experimental Examples 1 to 3 are 9.2 mT, 4.6 mT, and 10.3 mT, respectively. The larger the volume percentage of the neodymium-based magnetic powder, the larger the surface magnetic flux density. The surface magnetic flux densities in the natural length state of Experimental Examples 3 and 5 are 10.3 mT and 14.6 mT, and it can be seen that the larger the particle diameter of the neodymium-based magnetic powder, the larger the surface magnetic flux density. The surface magnetic flux densities in the natural length state of Experimental Examples 3 and 4 are 10.3 mT and 9.2 mT, and the surface magnetic flux density is larger in Experimental Example 3. The surface magnetic flux densities in the state of being compressed by 10%, 25%, and 50% of Experimental Examples 3 and 4 are 10.5 mT and 9.9 mT, 10.7 mT and 10.6 mT, and 10.9 mT and 12.6 mT, respectively. The respective rates of change were 1.9% and 7.6%, 3.9% and 15.2%, and 5.8% and 37.0. In the 50% compression state, the surface magnetic flux density is larger in Experimental Example 4. This is considered to be because, when compressed, not only the distribution density of the neodymium-based magnetic powder increases, but also the directions of the magnetic moments of the neodymium-based magnetic powder are more aligned as compared with the natural length state, which increase both the number n of the neodymium-based magnetic powder per unit volume and the average value mz of the magnetic moments in the above relational formula (B), increase the magnetization Mz, and also increase the rate of change as compared with the natural length state. It is considered that the increase in the magnetization Mz results in an increase in the magnetic flux density Bz (see the relational formula (A)). In addition, in Experimental Example 3, the rate of change in the surface magnetic flux density with respect to the natural length state is 5.8% when 50% compression is performed, whereas in Experimental Example 4, the rate of change with respect to the natural length state is 7.6% when 10% compression is performed. Thus, it is possible to increase the change in the surface magnetic flux density (magnetic flux density) even when the degree of elastic deformation is small.

Comparison of the amounts of power generation of Experimental Example 1 and Experimental Example 3 shows that the amount of power generation increases as the mass percentage (volume percentage) of the neodymium-based magnetic powder increases. In addition, it can be seen that the amount of power generation increases as the compressibility (displacement amount) increases and the frequency increases.

### Other Embodiments

(1) For example, a configuration is also conceivable in which a magnetic sensor such as a Hall element, a tunnel magnetoresistive effect element (TMR element), a giant magnetoresistive effect element (GMR element), or an anisotropic magnetoresistive effect element (AMR element), as a device that detects the behavior of a member of the like using the change in the magnetic flux density along with the elastic deformation of the magnetic elastic body 20, is disposed facing the magnetic elastic body 20.
(2) Although all the electric devices 100A to 100I described above operate with the electric power generated by the power generation unit 10, the electric power may be secured by a battery or an external power supply (for example, a commercial power supply) without using the power generation unit 10 as the power generation unit, and the power generation unit 10 may be used only as a detection unit that detects an external force, deformation of a member, and the like, or the load unit need not be provided.
(3) Similarly to the electric device 100I of the ninth embodiment described above that can be used for torsional deformation, bending deformation, and extension and contraction deformation, all the electric devices 100A to 100I described above may be used in other ways. In addition, the electrical loads included in the load units of the electric devices 100A to 100I may be appropriately changed.
(4) Although the magnetic elastic body 20 of the first embodiment is disposed inside the electromagnetic induction coil 12, the magnetic elastic body 20 may be disposed outside the electromagnetic induction coil 12 as long as the magnetic field by the magnetic powder 22 of the magnetic elastic body 20 passes through the inside of the electromagnetic induction coil 12.
(5) In the above embodiment, the magnetization direction of the magnetic elastic body 20 is the same as the axial direction of the electromagnetic induction coil 12, but may be inclined with respect to the axial direction of the electromagnetic induction coil 12.
(6) In the above embodiment, the magnetic elastic body 20 has a columnar shape, but is not limited thereto, and may have a rectangular shape or a spherical shape. In addition, the magnetic elastic body 20 may have a product shape such as the above-described bound stopper (see FIG. 11(B)).
(7) In the above embodiment, the electromagnetic induction coil 12 and the magnetic elastic body 20 are disposed coaxially. However, the central axes of the electromagnetic induction coil 12 and the magnetic elastic body 20 may be disposed in parallel to be shifted from each other, or may be inclined from each other.
(8) Since the magnetic elastic body 20 has a structure in which the magnetic powder 22 is dispersively disposed in the foamed elastomer 21, the magnetic elastic body 20 can be easily cut into any shape, and the cut body is also a magnet having an N pole and an S pole. Therefore, the magnetic elastic body 20 may be used for a toy. In addition, since the magnetic elastic body 20 is lighter than a ferrite magnet or the like, the magnetic elastic body 20 can also be used for the purpose of floating by a magnetic force of another magnet or the like.
(9) In the above embodiment, 1,5 naphthalene diisocyanate (NDI) is used as the raw material isocyanate of the magnetic elastic body 20. However, diphenylmethane diisocyanate (MDI) may be used.

### <Note>

Hereinafter, features of an invention group extracted from the above embodiments will be described while showing effects and the like, as necessary. In the following, for easy understanding, corresponding configurations in the above embodiments are appropriately indicated in parentheses or the like. However, the present disclosure is not limited to the specific configurations indicated in the parentheses or the like.

### [Feature A1]

An electric device including: an electromagnetic induction coil; an elastic body containing a magnetized magnetic powder and configured to generate a magnetic field passing through the electromagnetic induction coil and to change a magnetic flux density of the magnetic field when elastically deformed by receiving an external force; a rectifier unit configured to rectify an induced current induced in the electromagnetic induction coil by a change in the magnetic flux density; and a load unit configured to operate by receiving the induced current from the rectifier unit.

The electric device of feature A1 includes the elastic body containing the magnetized magnetic powder and configured to generate the magnetic field passing through the electromagnetic induction coil. When the such elastic body is elastically deformed by receiving the external force, the magnetic flux density of the magnetic field passing through the electromagnetic induction coil changes, and self-power generation is performed by electromagnetic induction. The induced current flowing through the electromagnetic induction coil is rectified and applied to the load unit to drive the load unit. As described above, the electric device of feature A1 can perform the self-power generation using the elastic body having a simpler structure as compared with a rotary machine of a conventional electric device.

### [Feature A2]

The electric device according to feature A1, wherein the load unit includes a wireless circuit configured to output a wireless signal in response to the receiving of the induced current from the rectifier unit.

Since the electric device of feature A2 includes the wireless circuit in addition to performing the self-power generation, the degree of freedom of selecting its installation place is increased.

### [Feature A3]

The electric device according to feature A2, wherein the wireless circuit outputs the wireless signal every time the wireless circuit receives the induced current from the rectifier unit to notify that the elastic body receives the external force.

The electric device of feature A3 can be installed at a portion receiving the external force to monitor a state of the external force from a remote place.

### [Feature A4]

The electric device according to any one of features A1 to A3, wherein the load unit includes a detection circuit configured to generate detection data for specifying the external force based on the induced current, and a wireless circuit configured to wirelessly transmit the detection data.

Since the electric device of feature 4 generates the detection data for specifying the external force on the basis of the induced current and then wirelessly transmits the detection data, it is possible to collect data that is hardly affected by noise due to wireless transmission at a remote value away from the electric device.

### [Feature A5]

The electric device according to any one of features A1 to A4, wherein the rectifier unit includes a secondary battery that is charged by the induced current to enable power supply to the load unit.

In feature 5, the power supply to the load unit is stabilized by including the secondary battery.

[Feature A6]

The electric device according to any one of features A1 to A5, wherein a direction of a magnetic moment of the magnetic powder changes along with an elastic deformation of the elastic body, and the magnetic flux density of the magnetic field passing through the electromagnetic induction coil changes.

In order to change the magnetic flux density of the magnetic field, a distribution density of the magnetic powder that generates the magnetic field passing through the electromagnetic induction coil may be changed by the deformation of the elastic body, or the direction of the magnetic moment of the magnetic powder may be changed between an aligned state in the axial direction of the electromagnetic induction coil and a non-aligned state in the axial direction of the electromagnetic induction coil as in feature 6.

### [Feature A7]

The electric device according to any one of features A1 to A6, wherein the electromagnetic induction coil is wound in an annular or cylindrical shape having a space for receiving the elastic body inside, the electric device including an extension and contraction support mechanism configured to transmit the external force to extend and contract the elastic body in a winding axis direction of the electromagnetic induction coil.

According to feature 7, it is possible to efficiently generate electric power with a compact structure.

### [Feature A8]

The electric device according to any one of features A1 to A6, including a torsion support mechanism configured to transmit the external force to twist the elastic body around a winding axis of the electromagnetic induction coil.

In feature 8, it is possible to generate electric power using a rotating external force.

### [Feature A9]

The electric device according to any one of features A1 to A8, wherein the elastic body is a foamed elastomer.

Since the elastic body of feature A9 is a foamed elastomer, the bubbles are squeezed when the elastic body is compressed, and expand when the elastic body is extended. As a result, a change in size in a direction perpendicular to the extension and contraction direction along with the extension and contraction deformation is suppressed, and interference between the elastic body and the surrounding components can be suppressed.

### [Feature A10]

The electric device according to feature A9, wherein the foamed elastomer is a polyurethane elastomer, and the magnetic powder has a particle diameter of 3 to 200 μm.

In feature A10, since the elastic body is a polyurethane elastomer, curing of the raw material of the elastic body can be accelerated. For example, in a case where the elastic body is non-foamed silicon rubber, it takes time to cure the elastic body. Thus, the magnetic powder precipitates during the curing of the elastic body, and the dispersion of the magnetic powder in the elastic body tends to be uneven. On the other hand, in feature A10, the raw material of the elastic body can be cured before the magnetic powder precipitates, and the magnetic powder can be uniformly dispersed in the elastic body. As a result, even the magnetic powder having a particle diameter of 100 μm or more can be easily dispersed, and the magnetic flux density of the elastic body can be increased. In addition, from the viewpoint of the moldability, deformability, and the like of the elastic body, the particle diameter of the magnetic powder is preferably 200 μm or less.

### [Feature A11]

The electric device according to feature A9 or feature A10, wherein the foamed elastomer has an expansion ratio of 1.4 to 6 times and at least partially has an open-cell structure.

In feature A11, since the foamed elastomer has an expansion ratio of 1.4 to 6 times and has at least an open-cell structure, the elastic body can be easily molded and elastically deformed, and thereby the magnetic flux density of the elastic body can be easily changed. As a result, the induced current can be easily generated in the circuit. In addition, since the foamed elastomer at least partially has an open-cell structure, the foamed elastomer can be inhibited from contracting (so-called shrinking) after being molded. The above expansion ratio indicates the expansion ratio of the foamed elastomer alone, not the expansion ratio of the elastic body.

### [Feature A12]

The electric device according to any one of features A9 to A11, wherein the magnetic powder is formed of a hard ferromagnetic material, the magnetic powder has a mass concentration of 40 to 80% with respect to the foamed elastomer, and the magnetic powder has a volume concentration of 1.0 to 3.5% with respect to the foamed elastomer.

In feature A12, it is possible to increase the change in the magnetic flux density of the elastic body while facilitating the elastic deformation of the elastic body.

### [Feature A13]

The electric device according to any one of features A1 to A12, wherein the elastic body has a compression set of 30% or less in accordance with JIS K 6262:2013 A method.

### [Feature A14]

The electric device according to any one of features A1 to A13, wherein the elastic body has a cyclic compressive strain of 20% or less in a case where 50% compression is repeated 100000 times at 1 Hz.

According to features A13 and 14, restoration after the foamed elastomer is elastically deformed is favorable. As a result, even in a case where the elastic body is used in an application where the elastic body is repeatedly compressed and used, fatigue of the foamed elastomer is reduced, and the elastic body becomes more suitable for repeated use.

### [Feature A15]

A method for producing the electric device according to any one of features A1 to A14, the method including: dispersing the magnetic powder in the elastic body; and magnetizing the magnetic powder in a compression direction of the elastic body in a state where the elastic body is elastically deformed.

According to the producing method of feature A15, it is possible to easily produce the elastic body having a large amount of change in the magnetic flux density when compressed.

Although specific examples of the technology included in the claims are disclosed in the present specification and the drawings, the technology described in the claims is not limited to these specific examples, and includes those obtained by variously modifying and changing the specific examples, and also includes those obtained by singly extracting a part from the specific examples.

### REFERENCE SIGNS LIST

10 Power generation unit
12, 12V Electromagnetic induction coil
20, 20V, 20W Magnetic elastic body (elastic body)
21 Foamed elastomer
22 Magnetic powder
35 Adjustment mechanism
91, 91V, 91W Rectifier unit
91A Secondary battery
92. 92V Load unit
100A to 100I Electric device

1.-8. (canceled)

9. An electric device comprising:
an electromagnetic induction coil;
an elastic body containing a magnetized magnetic powder and configured to generate a magnetic field passing through the electromagnetic induction coil and to change a magnetic flux density of the magnetic field when elastically deformed by receiving an external force;
a rectifier unit configured to rectify an induced current induced in the electromagnetic induction coil by a change in the magnetic flux density;
a load unit configured to operate by receiving the induced current from the rectifier unit; and
a case accommodating the electromagnetic induction coil and the elastic body and being extensible and contractible together with the elastic body.

10. The electric device according to claim 9, wherein the case is a non-magnetic body.

11. The electric device according to claim 9, wherein the case includes a pair of cylindrical bodies partially fitted to each other.

12. The electric device according to claim 9, wherein the rectifier unit includes a secondary battery that is charged by the induced current to enable power supply to the load unit.

13. The electric device according to claim 9, wherein the load unit includes a wireless circuit configured to output a wireless signal in response to the receiving of the induced current from the rectifier unit.

14. The electric device according to claim 9, wherein the elastic body is a foamed elastomer.
